(19) United States
(12) Patent Application Publication
(10) Pub. No.: US 2007/0061804 A1
(43) Pub. Date: Mar. 15, 2007

(54) Apparatus, system, and method for managing task instances

(76) Inventors: Thomas Rudolf Anzelde, San Jose, CA (US); Horatiu-Iulian Caranica, Bucharest (RO); Zhao Lu, Campbell, CA (US); Christopher Jacob Rich, Tigard, OR (US)

Correspondence Address: KUNZLER & ASSOCIATES, 8 EAST BROADWAY, SUITE 600, SALT LAKE CITY, UT, 84111, US

(21) Appl. No.: 11/218,862

(22) Filed: Sep. 2, 2005

(51) Int. Cl. G06F 9/46

(52) U.S. Cl. 718/100

(57) ABSTRACT

An apparatus, system, and method are disclosed for managing task instances. The present invention includes receiving a task instance request with a unique task identifier and invoking an authorization function corresponding to the unique task identifier. The authorization function authorizes the task instance request and registers the unique task identifier if the unique task identifier is not currently registered. If the unique task identifier is currently registered, the authorization function performs a task-specific operation. In certain embodiments the present invention also includes a task repository for storing unique task identifiers and a task termination function for unregistering unique task identifiers.

### BACKGROUND OF THE INVENTION

1. Field of the Invention

This invention relates to managing task instances and more particularly relates to managing task instances using a task repository and task-specific operations.

2. Description of the Related Art

Performing tasks is a frequent objective of many programmable devices. A task often includes opening or closing a GUI panel such as a window containing a document, inventory list, employee roster, or slide presentation. Also common among tasks, is the ability to open multiple instances of the same task. For example, multiple GUI panels of the same document, report, or inventory list.

The absence of an instance management system provides an unrestrained and problematic ability to open multiple instances of the same task. For example, opening multiple instances of the same document may allow a user to delete data from one instance of the document without an automated process for updating the other instances of the document. Consequently, the data contained in the remaining document instances is inaccurate and out-of-date.

Conversely, an over-restrictive instance management system may purge the computer system from operating at full potential. For example, the management system may only allow for one instance of each task. Though this may protect against the foregoing problem where instances may end up containing inaccurate and out-of-date data, this solution does not allow multiple instances where it may be beneficial. For example, in a network where multiple computer consoles remotely view inventory reports on a centralized server, it would be beneficial to have a instance managing system that enables multiple instances such that the same inventory report could be seen on multiple computer consoles simultaneously. Consequently, an overly restrictive task management system is detrimental.

Additionally, an instance management system may be complicated, ad-hoc, or bulky, such that customizing task instance management becomes a cumbersome responsibility. For example, if an instance management system were to provide even a minimal level of customization, the system may be so bulky and complicated as to be taxing on the resources of the system or be difficult to adapt to new tasks and their associated instances. Such a complicated system would undermine system efficiency and an ability to implement new tasks.

From the foregoing discussion, it should be apparent that a need exists for an apparatus, system, and method that manage task instances. Beneficially, such an apparatus, system, and method would provide a means for managing task instances in an organized, efficient, and customized manner.

### SUMMARY OF THE INVENTION

The present invention has been developed in response to the present state of the art, and in particular, in response to the problems and needs in the art that have not yet been fully solved by currently available solutions. Accordingly, the present invention has been developed to provide an apparatus, system, and method for managing task instances that overcome many or all of the above-discussed shortcomings in the art.

The apparatus for managing task instances includes a plurality of modules configured to functionally execute the necessary operations to managing task instances. The modules in the described embodiments include a coordination module, an interface module, a processing module, and a data storage module. The coordination module receives a task instance request with a unique task identifier and invokes an authorization function. The task instance request may include a request to open a graphical user interface (GUI) panel such as a window containing inventory data.

The authorization function authorizes the task instance request and registers the unique task identifier if the unique task identifier is not currently registered. A currently registered unique task identifier may include a unique task identifier stored in a task repository such as an array, vector, hashmap, or the like. Registering a unique task identifier may include adding the unique task identifier to the task repository and incrementing a task instance counter that represents the number of active instances for each task.

If the unique task identifier is currently registered, the authorization function performs a task-specific operation. The task-specific operation may include, but is not limited to, producing a warning dialog, authorizing the task instance request, obtaining the current task instance count, terminating a task instance request, registering the unique task identifier, incrementing a task instance count, and activating a read-only mode. In one embodiment the coordination module may also unregister a unique task identifier by invoking a task termination function in response to a task termination request. Accordingly, the apparatus provides an organized, efficient, and customizable means for managing task instances.

A system of the present invention is also presented for managing task instances. The system may be embodied as any programmable device or compilation of programmable devices capable of managing task instances. In one embodiment, the system includes a programmable device, such as a task server, that receives a task instance request with a unique task identifier. The server authorizes task instance request and registers the unique task identifier if the unique task identifier is not currently registered. A registered unique task identifier may include a unique task identifier stored in a task repository such as an array, vector, hashmap, or the like.

If the unique task identifier is registered, the server performs a task-specific operation. A task-specific operation may include producing a warning dialog, authorizing the task instance request, obtaining the current task instance count, terminating a task instance request, registering the unique task identifier, incrementing a task instance count, and activating a read-only mode. In certain embodiments, the programmable device may also unregister a unique task identifier by invoking a task termination function in response to a task termination request.

A method of the present invention is also presented for managing task instances. The method in the disclosed embodiments substantially includes the operations necessary to carry out the functions presented above with respect to the operation of the described apparatus and system. In one embodiment, the method includes receiving a task instance request with a unique task identifier and invoking an authorization function that authorizes the task instance request and registers the unique task identifier if the unique task identifier is not currently registered in a task repository.

The authorization function also performs a task-specific operation if the unique task identifier is currently registered in a task repository. In certain embodiments, the method also includes unregistering a unique task identifier by invoking a task termination function in response to a task termination request. Accordingly, the present invention provides an organized, efficient, and customizable means for managing task instances.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a task instance managing system in accordance with the present invention;

FIG. 2 is a schematic block diagram illustrating one embodiment of a task instance managing apparatus in accordance with the present invention;

FIG. 3 is a schematic flow chart diagram illustrating one embodiment of a method for managing task instances in accordance with the present invention;

FIGS. 4a-f are a sequence of static depictions of one embodiment of a GUI and associated task repository in accordance with the present invention; and

FIGS. 5a-c are a sequence of state diagrams illustrating one embodiment of a GUI and associated task repository in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

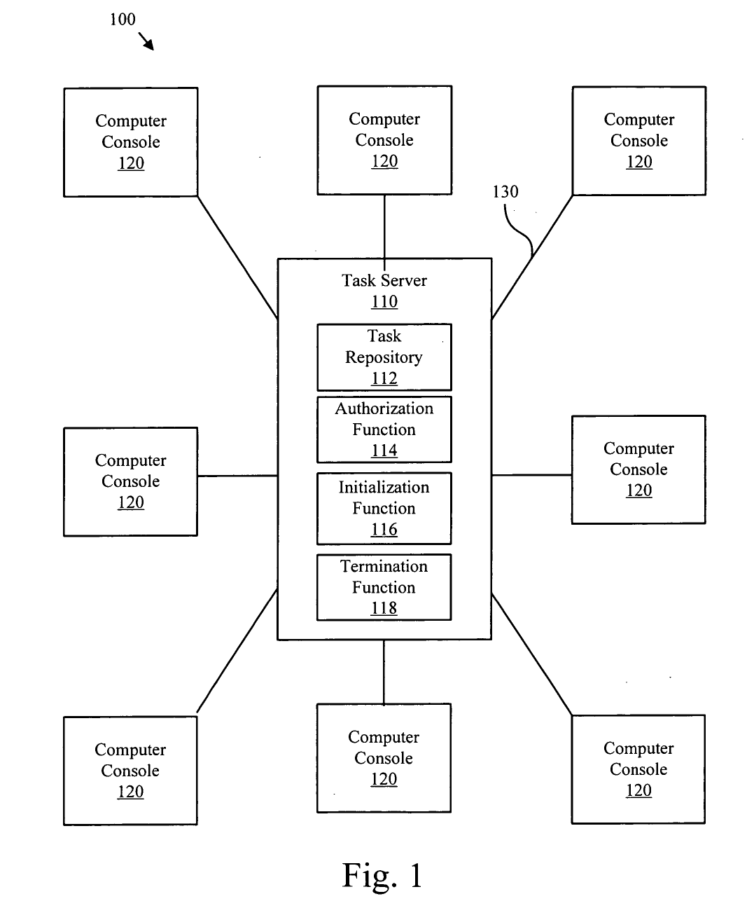

FIG. 1 is a block diagram of a task instance managing system 100. The depicted system 100 includes a task server 110, a task repository 112, an authorization function 114, an initialization function 116, a termination function 118, computer consoles 120, and a networking means 130. The computer consoles 120 in the illustrated system 100 remotely perform tasks on the server 110 via the networking means 130. Performing a task may include opening or closing a type of GUI panel such as a window containing a list of inventory. The various components of the system 100 function cooperatively to manage task instances in an organized and customizable manner.

The server 110 receives task instance requests from the computer consoles 120. Each task instance request includes a unique task identifier. A unique task identifier may be any sequence or combination of numbers, letters, or symbols capable of uniquely identifying a task.

The server 110 authorizes a task instance request if the unique task identifier is not currently registered. A currently registered unique task identifier may include a unique task identifier stored in a task repository 112. Providing a task repository 112 creates an organized representation for all active tasks. In certain embodiments, the server 110 includes a separate task repository 112 for each console 120, allowing each console 120 to perform the same task independent from one another. In some embodiments, certain repositories are assigned to selected tasks or console groups. In certain embodiments, authorizing tasks may be combined with an initialization function 116 to facilitate initializing task instances.

The server 110 registers the unique task identifier if the unique task identifier is not currently registered. Registering a unique task identifier may include adding the unique task identifier to the task repository 112. Registering each unique task identifier enables the server to keep a current log of all active tasks. The server 110 may also increment a task instance counter that represents the total number of active instances for each task.

The server 110 may determine via an atomic operation if the unique task identifier is currently registered. An atomic operation ensures only one unique task identifier search is performed at a time. For example, if multiple consoles 120 each submit a task instance requests at approximately the same type, the server 110 may place a lock on the task repository 112 such that only one unique task identifier may be searched for at a time. If simultaneous searches were allowed the system would run the risk of erroneously authorizing multiple instances of the same task.

The server 110 performs a task-specific operation if the unique task identifier is already registered. A task-specific operation may include, but is not limited to, producing a warning dialog, authorizing the task instance request, obtaining the current task instance count, registering the unique task identifier, and so on. The task-specific operation assigned to each task may depend upon the nature of the task.

The server 110 may also unregister unique task identifiers by invoking a task termination function 118 in response to a task termination request. A task termination request may originate from a variety of sources including, for example, a user selecting a GUI panel cancel button. Unregistering a unique task identifier may include removing the unique task identifier and associated task counter value from the task repository 112. Providing a means for unregistering task identifiers enables the present invention to ensure the task repository 112 is always current.

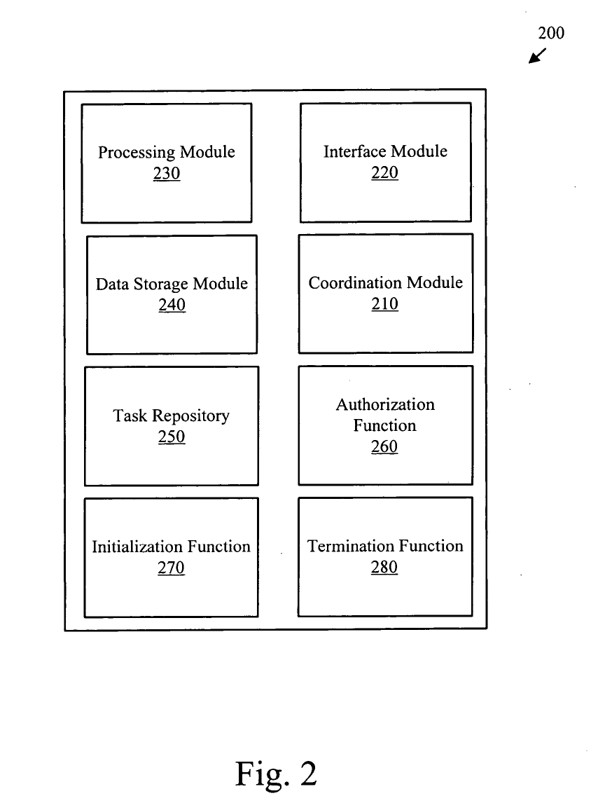

FIG. 2 is a schematic block diagram of a task instance manager 200. The depicted task instance manager 200 includes a coordination module 210, an interface module 220, a processing module 230, a data storage module 240, a task repository 250, an authorization function 260, an initialization function 270, and a termination function 280. The apparatus 200 may be any programmable device capable of managing task instances such as an independent computer console. The various components of the apparatus 200 cooperate to manage task instances in an organized and customizable manner.

The coordination module 220 receives task instance requests from the interface module 220. Each task instance request includes a unique task identifier. A unique task identifier may be any sequence or combination of numbers, letters, or symbols capable of uniquely identifying a task. In certain embodiments, the unique task identifier is the name of a method that performs the task.

The coordination module 210 also invokes an authorization function 260 corresponding to the unique task identifier. The authorization function 260 authorizes the task instance request if the unique task identifier is not currently registered. A currently registered unique task identifier may be a unique task identifier stored in a task repository 250.

A task repository 250 may be any type of software data structure capable of storing unique task identifiers such as an array, a vector, a hash map, or the like. In certain embodiments, the apparatus 200 may include multiple repositories designated for different tasks such that only certain tasks or groups of task are registered therein. Providing a task repository 250 for storing current task instances facilitates the present invention's managerial operations by providing a centralized and organized storage area for unique task identifiers. In certain embodiments, authorizing tasks may be combined with an initialization function 270 to facilitate initializing task instances.

The authorization function 260 also registers the unique task identifier if the unique task identifier is not currently registered. Registering the unique task identifier may include adding the identifier to the task repository 250. For example, if the task repository 250 is a hash map, registering the unique task identifier may include adding the identifier to the hash map according to the hash map index.

The authorization function 260 may also increment a task instance counter with each newly registered unique task identifier. In scenarios involving multiple instances of the same task, the authorization function 260 may register the first instance of the task by adding the unique task identifier to the task repository 250 and setting the task instance counter to one. For subsequently authorized task instances, the authorization function 260 may forego adding an additional unique task identifier to the task repository 250 and instead increment the task instance counter by one. In certain embodiments, the task instance counter may be included in the task repository 250. The task instance counter enables the present invention to maintain a current log of the instances for each task, while minimizing the volume of the task repository 250.

The authorization function 260 110 may also determine via an atomic operation if the unique task identifier is currently registered. An atomic operation ensures only one task repository 250 search is performed at a time. In certain embodiments, an atomic operation includes the coordination module 210 placing a lock on the task repository 250 such that only a single task repository 250 search may be performed. In certain embodiments, the task repository 250 lock may be task-specific such that the lock only affects task instance request pertaining to the same task. Providing an atomic operation ensure the apparatus 200 will not simultaneously authorize identical task instance requests.

If simultaneous searches were allowed the system would run the risk of erroneously authorizing multiple instances of the same task. For example, in a scenario wherein a task repository 250 contains no instances of task A, if the authorization function 260 were to perform two simultaneous searches for task A, the authorization function 260 would authorize and record both instance requests because the task repository 250 searches would reveal no currently registered instances of task A. Such a scenario would be especially problematic when involving a data sensitive task that was not intended to enable multiple task instances.

In other embodiments, the coordination module 210 may instead send a message to the user explaining that the task cannot be performed or that another process is in progress and the task should be requested again later. Enabling the coordination module 210 to perform an atomic operation provides an additional means of ensuring proper task management.

The authorization function 260 may also perform a task-specific operation if the unique task identifier is currently registered. A task-specific operation may include producing an error dialog, producing a warning dialog, authorizing the task instance request, obtaining the current task instance count, terminating a task instance request, registering the unique task identifier, incrementing a task instance count, and activating a read-only mode. The task-specific operation assigned to each task may depend upon the nature and objectives of the task.

For example, producing multiple instances of a task such as viewing an inventory report may present no risk in producing multiple instances. Accordingly, the task-specific operation corresponding to viewing inventory reports may include authorizing and recording the task instance request. However, a task that involves altering data may not be congenial to multiple tasks instances as deleting the data in one panel instance may not include an operation to subsequently update the other panel instances, thereby creating panel instances with inaccurate data. Accordingly, the task-specific operation corresponding to tasks involving altering data may include providing an error dialog to the user and initiating a task request termination operation.

Other tasks may be best suited for a read-only mode. For example, a user may desire to invoke a task that enables users on different consoles to view a document. Assigning a read-only mode as the task-specific operation would allow users to simultaneously view multiple instances of the document but not enable the users to change the information contained therein. Such a task-specific operation may be accompanied by providing the user with a message indicating the read-only mode imposed upon the task instance. Task-specific operations enable the system 100 to further customize task instance management.

The coordination module 210 may also unregister a unique task identifier by invoking a task termination function 280 in response to a task termination request. The task termination function 280 may remove the unique task identifier from the task repository 250 and reduce the task counter accordingly. In scenarios involving multiple instance of a task, unregistering one task instance may only include reducing the task instance counter by one. Accordingly, the apparatus 200 provides an efficient and customizable means for managing task instances.

The data storage module 240 may comprise RAM (Random Access Memory) such as SRAM (Static Random Access Memory), DRAM (Dynamic Random Access Memory), SDRAM (Synchronous Dynamic Random Access Memory), DDR DRAM (Double Data Rate DRAM), MRAM (Magnetoresistive Random Access Memory), or any other random access memory as is known to those of skill in the art. Alternatively, the data storage module 240 may comprise other electronic memories such as EEPROM, flash PROM, MEMS (Micro-Electro Mechanical Systems) based storage, CompactFlash™, SD (Secure Digital) media™, Memory Stick™, or any other electronic memory as is known to those of skill in the art.

The schematic flow chart diagram that follows is generally set forth as a logical flow chart diagram. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Additionally, the order in which a particular method occurs may or may not strictly adhere to the order of the corresponding operations shown.

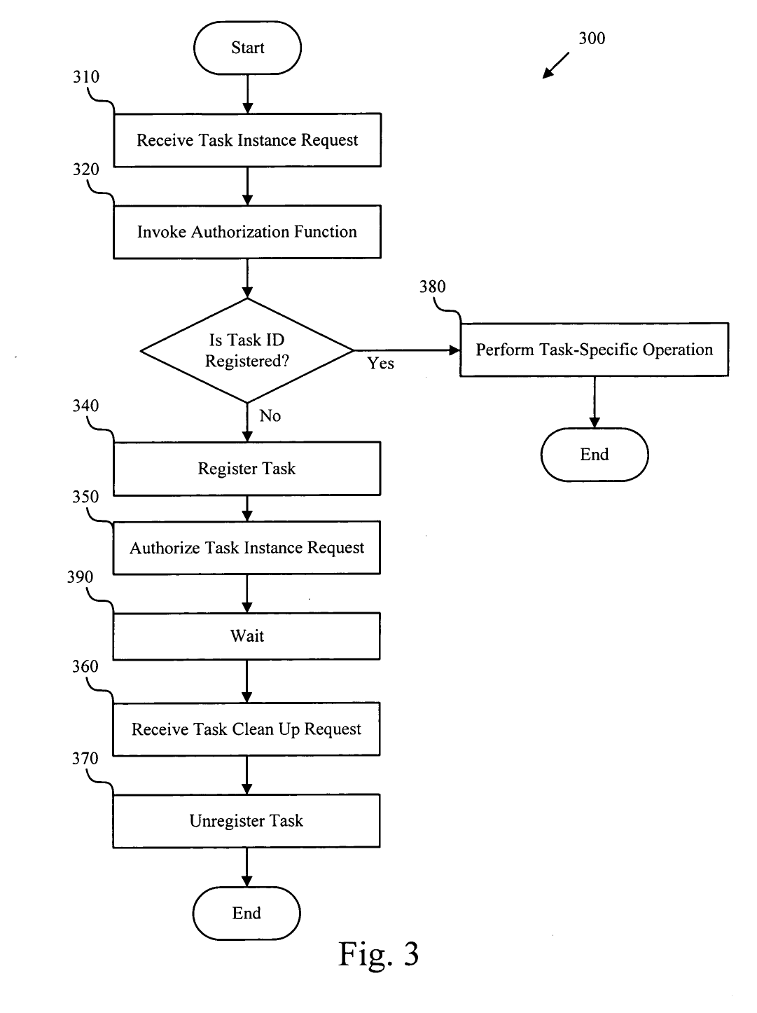

FIG. 3 is a schematic flow chart diagram of one embodiment of a method for managing task instances. The depicted method 300 includes the operations of receiving 310 a task instance request, invoking 320 an authorization function, registering 340 the unique task identifier, authorizing 350 the task instance request, performing 380 a task-specific operation, receiving 360 a task clean up request, and unregistering 370 a unique task identifier. The various operations of the method 300 provide a means for managing task instances.

Receiving 310 a task instance request may include a coordination module 210 receiving a task instance request with a unique task identifier. A task instance request may include, for example, a request to open or close a GUI panel containing a list of inventory data. A unique task identifier may include any sequence or combination of numbers, letters, or symbols capable of uniquely identifying a task. In certain embodiments, the unique task identifier is the name of the software method assigned to performing the task. Uniquely identifying each task ensures that no task will be confused for another.

Invoking 320 an authorization function may include authorizing the task instance request if the unique task identifier is not currently registered. A registered unique task identifier may include a unique task identifier stored in a task repository. A task repository may include any type of software data structure capable of storing unique task identifiers such as an array, vector, or hashmap. In certain embodiments, the task repository is stored in volatile memory such as random access memory (RAM). In certain embodiments, the authorization function determines the registration status of the unique task identifier by comparing the unique task identifier with the currently registered unique task identifiers.

If the unique task identifier is not currently registered the authorization function registers the unique task identifier. Registering 340 the unique task identifier may include adding the unique task identifier to the task repository. For example, registering 340 may include inserting the unique task identifier in an available position in the task repository array. The authorization function may also increment a task instance counter that provides the current number instances for each task. Once the task is registered, the authorization function authorizes the task instance request. Authorizing 350 the task instance request may include allowing or enabling the requested task to be performed. For example, a task may be authorized by providing an appropriate Boolean value to the software framework.

If, however, the authorization function determines that the unique task identifier associated with the requested task is currently registered, then the authorization function performs a task-specific operation. Performing 380 a task-specific operation may include any combination of producing a warning dialog, authorizing the task instance request, obtaining the current task instance count, terminating a task instance request, registering the unique task identifier, incrementing a task instance count, or activating a read-only mode.

For example, some task-specific operations will provide an error message to a user and terminate the task instance request. Other task-specific operations may provide a warning to the user, but allow the user to nevertheless open an additional instance of a task under in a read-only mode. In such a scenario, task-specific operation may also include authorizing the task instance request and recording the unique task identifier in the task repository to maintain a current representation of active tasks and task instances. Providing a task-specific operation enables the present invention to customize task management operations as different tasks have different needs.

Once the unique task identifier is recorded and the task instance request is authorized the method 300 provides the operation of waiting 390 for another command. Such a command may include receiving 310 another task instance request, or receiving 370 a task clean up request. Receiving 360 a task instance clean up request may include, for example, receiving notification that a user has selected the cancel button in an active task panel.

Upon receiving 360 a task clean up request, the coordination module 210 may proceed to unregister the corresponding unique task identifier. Unregistering 370 the unique task identifier depends upon the status of the registered unique task identifier. If there is currently only one active instance of the task in the task repository that corresponds to the task clean-up request, the unique task identifier is removed from the task repository and the task instance counter is accordingly reduced. However, if there are currently multiple task instances in the task repository, unregistering 370 may include merely reducing the task instance counter by the number of task instances terminated. Accordingly, the depicted method 300 provides an organized and customizable means for managing task instances.

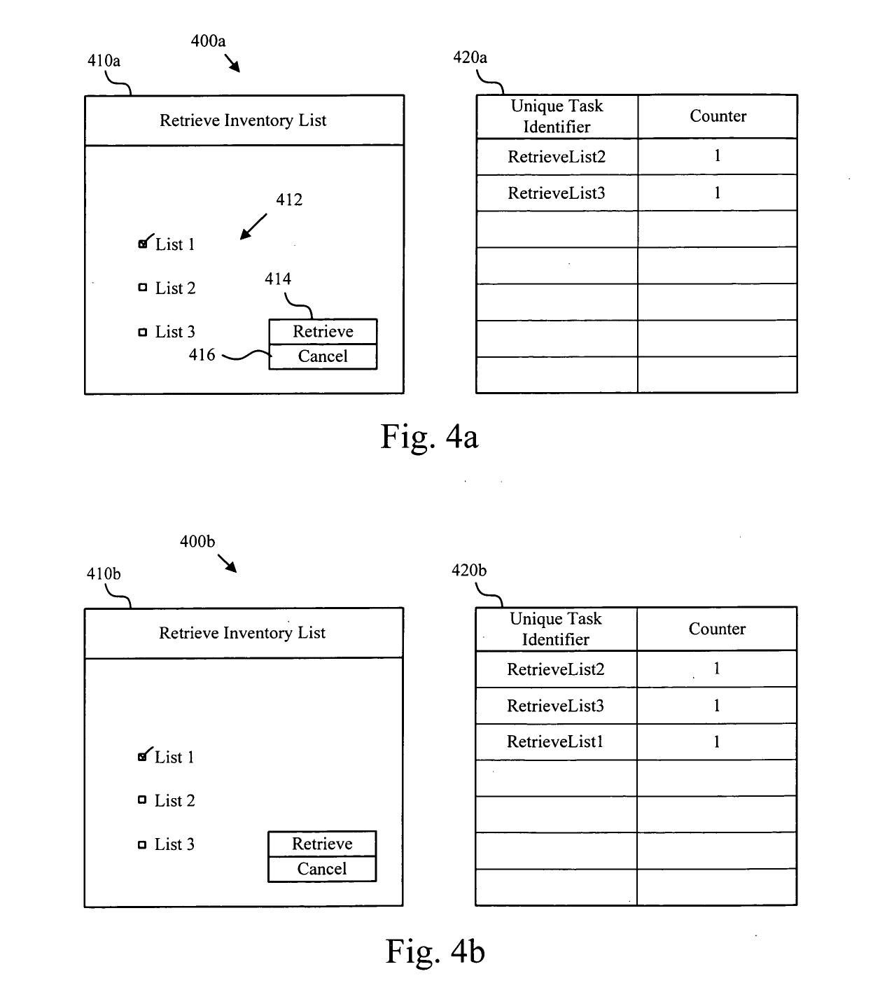

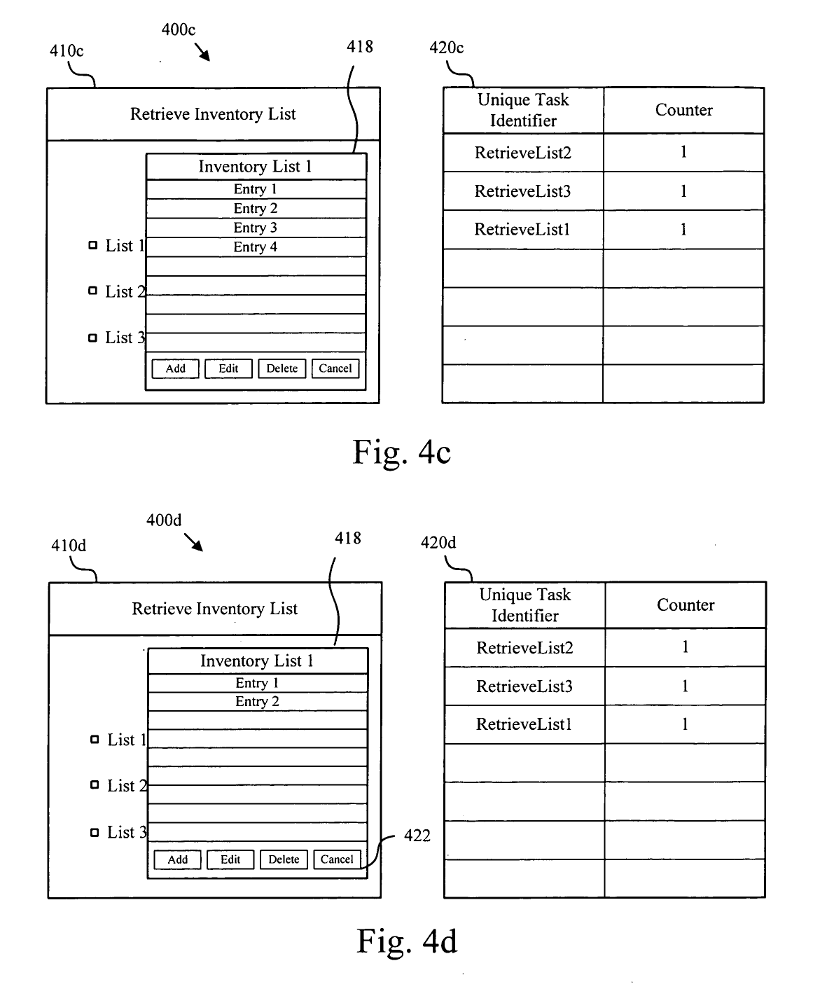

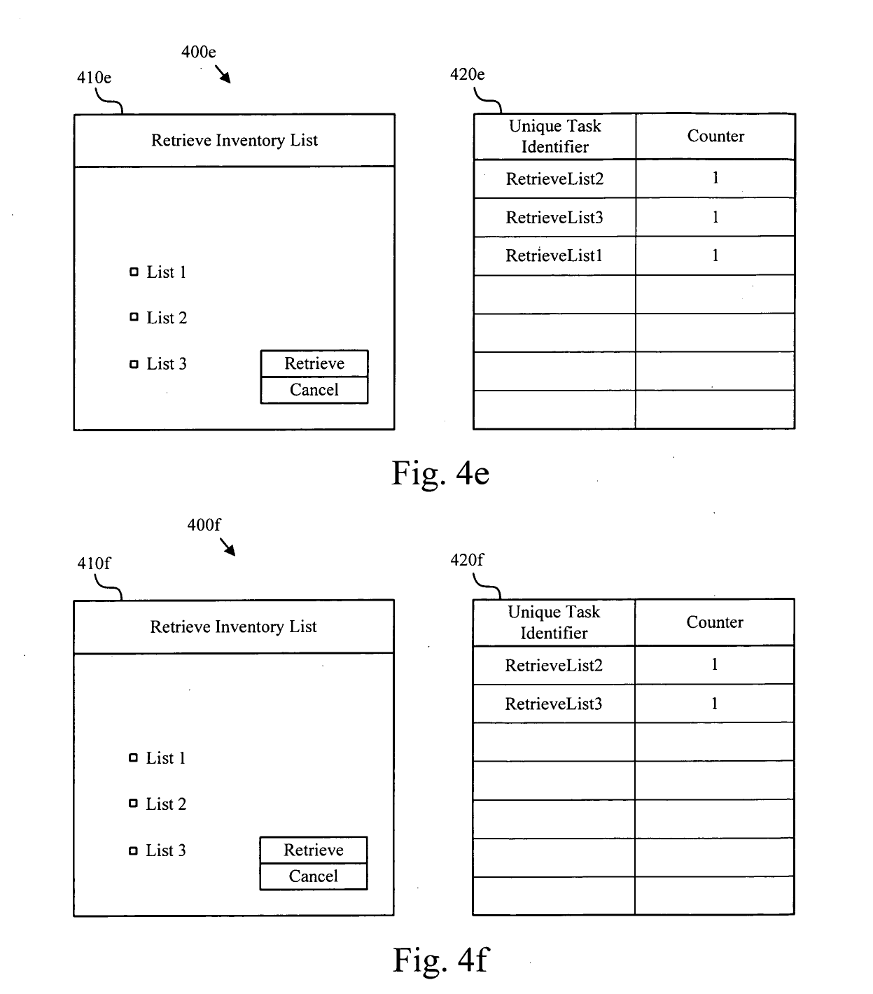

FIGS. 4a-f are a sequence of state diagrams depicting one embodiment of a GUI 410 and associated task repository 420. The state diagrams illustrate the step-by-step changes undergone by the GUI 410 and task repository 420 as a user retrieves Inventory List 1, deletes two entries therefrom, and closes the Inventory List. By way of example, the elements depicted in FIG. 4 correspond to the system 100 of FIG. 1. Accordingly, the GUI 410 of FIGS. 4a-f correspond to a GUI on a console 120 while the task repository of FIGS. 4a-f correspond to a server 110 (see FIG. 1). Consequently, the tasks associated with the tasks RetrieveList2 and RetrieveList3 are assumed to be currently active on other consoles 120 as they are already registered in the task repository 420.

Referring to state 400a shown in FIG. 4a, the GUI 410a includes selectable inventory lists 412, a retrieve button 414, and a cancel button 416. The task repository 420a stores the unique task identifier of each active task and provides an associated task counter value representing the number of active instances for each task. The user initiates a new retrieval request by checking the desired inventory list (List 1) and selecting the retrieve button 414.

As the user checks List 1 and selects the retrieve button 414, the server 110 receives an instance request having a unique task identifier (RetrieveList1). Accordingly, the server 110 invokes an authorization function corresponding to the unique task identifier. The authorization function records the unique task identifier if the unique task identifier is not currently registered. Determining whether the unique task identifier is recorded may include the authorization function comparing the unique task identifier to each unique task identifier registered in the task repository 420a.

As the unique task identifier RetreiveList1 is not registered in the task repository 420a, the authorization function adds the unique task identifier to the task repository 420b and increments the associated task instance counter to one (see FIG. 4b). The GUI 420b undergoes no change at this point. However; after the unique task identifier is registered in the task repository 420b, the authorization function authorizes the task instance request. Accordingly, the GUI 410c includes a panel 418 providing Inventory List 1 having four entries (see FIG. 4c). At this point, the task repository 420c experiences no change as the panel instance has already been recorded in the task repository 420c. Now that the task instance request has been authorized and completed, the user may alter the data found in the inventory panel 418.

Referring now to FIGS. 4c and 4d, as seen by comparing GUI 410c and GUI 410d, the user deletes two inventory entries from the Inventory List 1 panel 418. The task repository 420d experiences no change as no task instance commands to retrieve or terminate an instance panels have been initiated. Once the user finishes with Inventory List 1, the user selects the cancel button 422 to remove the inventory from the GUI 410e. At this point, the task repository 420e still experiences no change as the task termination function has not updated the task repository 420e.

Referring to FIG. 4f, now that Inventory List 1 has been terminated, a task termination function proceeds to unregister the unique task identifier from the task repository 420f by removing RetrieveList 1 and reducing the instance counter accordingly. The GUI 410f experiences no change at this point as Inventory List 1 panel 418 has already been removed from the GUI 420f. Accordingly, FIG. 4 illustrates the changes undergone by a GUI 410 and task repository 415 as a user retrieves Inventory Lists 1, removes two entries therefrom, and cancels the Inventory List.

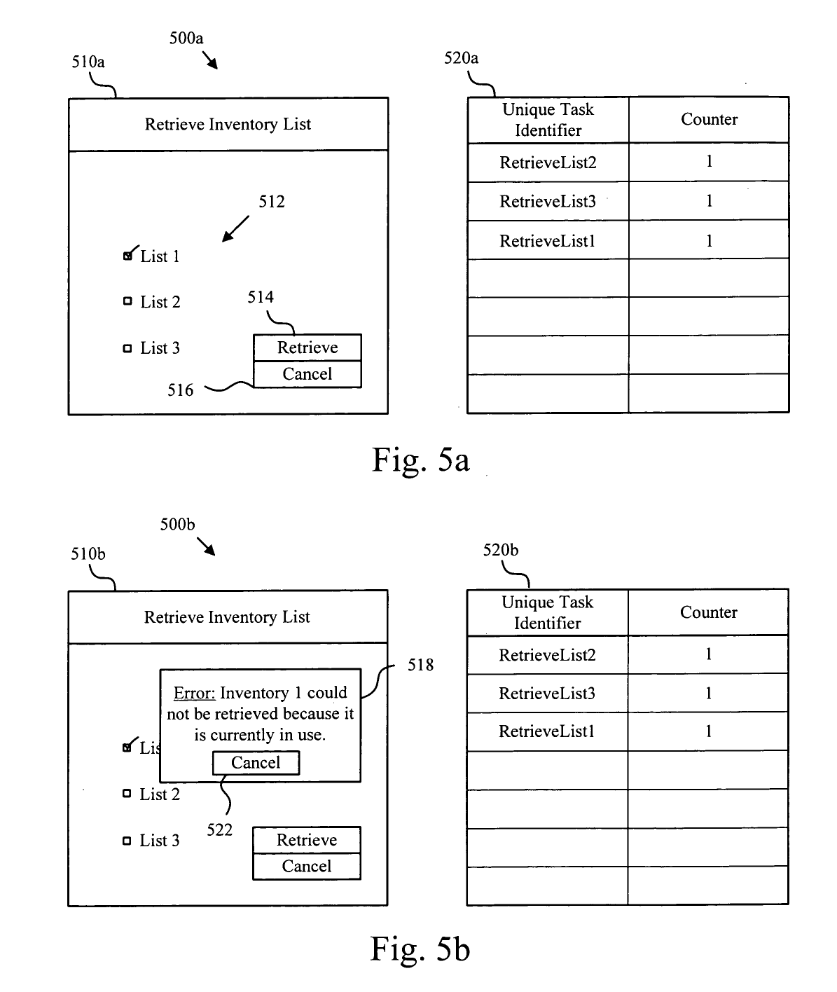

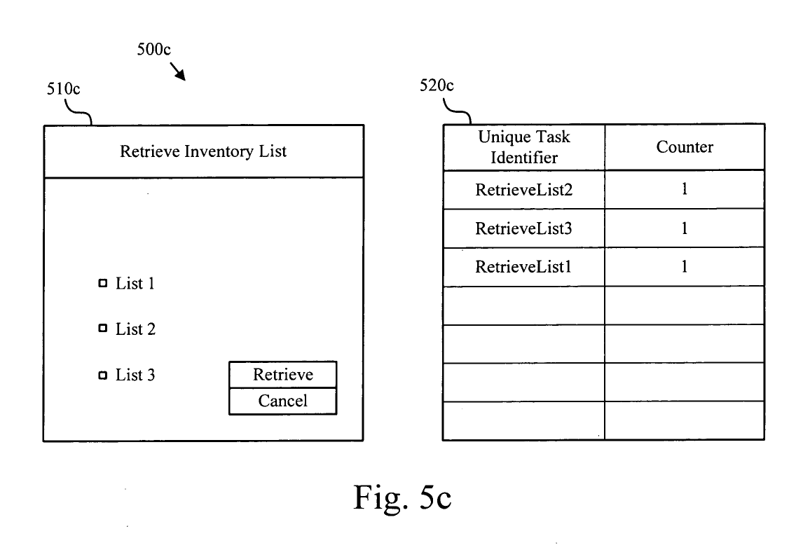

FIGS. 5a-c are a sequence of state diagrams depicting one embodiment of a GUI 510 and task repository 520. The state diagrams illustrate the changes undergone by the GUI 510 and task repository 520 as a user attempts to retrieve Inventory List 1 but is unable because the unique task identifier corresponding to Inventory List 1 is currently registered in the task repository 520. By way of example, the elements depicted in FIGS. 5a-c correspond to the system 100 of FIG. 1. Accordingly, the GUI 510 corresponds to a GUI on a console 120 while the task repository 520 corresponds to the server 110 (see FIG. 1). Consequently, a single instance of the tasks RetrieveList1, RetrieveList2 and RetrieveList3 are assumed to be currently active on other consoles 120 as they are already registered in the task repository 520.

Referring to FIG. 5a, the GUI 510a includes one or more selectable inventory lists 512, a retrieve button 514, and a cancel button 516. The task repository 520a includes a list of all currently active tasks and the task counter with the number of active instances for each task. The user initiates a retrieval request by checking the desired inventory list (Inventory List 1) and selecting the retrieve button 514.

As the user checks List 1 and selects the retrieve button 514, a coordination module 280 (see FIG. 2) receives a task instance request having a unique task identifier. The unique task identifier, in this example, is RetreiveList1. Accordingly, the coordination module 280 invokes an authorization function corresponding to the unique task identifier.

The authorization function records the unique task identifier if the unique task identifier is not currently registered. However, if the unique task identifier is currently registered, the authorization function performs a task-specific operation. As the task identifier RetreiveList1 is currently registered in the task repository 520a, the authorization function performs a task-specific operation.

Accordingly, the authorization function produces an error message 518 to the user as depicted in GUI 520b. The task repository 520b and task instance counter 520b remained unchanged because no unique task identifiers have been registered or unregistered. Having been presented the error message 518, the user may then select the cancel button 522 presented therein to remove the error message 518 as seen in GUI 510c of FIG. 5c. The task repository 520c remains unchanged.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for managing task instances, the apparatus comprising:
a coordination module configured to receive a task instance request, the task instance request comprising a unique task identifier;
the coordination module further configured to invoke an authorization function corresponding to the unique task identifier;
the authorization function configured to authorize the task instance request and register the unique task identifier if the unique task identifier is not currently registered; and
the authorization function further configured to perform a task-specific operation if the unique task identifier is currently registered.

2. The apparatus of claim 1, wherein the coordination module is further configured to unregister a unique task identifier by invoking a task termination function in response to a task termination request.

3. The apparatus of claim 1, wherein the authorization function is further configured to determine via an atomic operation if the unique task identifier is currently registered.

4. The apparatus of claim 1, wherein a registered unique task identifier comprises a unique task identifier stored in a task repository.

5. The apparatus of claim 4, where in the task repository is selected from the group consisting of an array, a vector, and a hashmap.

6. The apparatus of claim 1, wherein the authorization function is further configured to increment a task instance count with each newly registered unique task identifier.

7. The apparatus of claim 1, wherein the task-specific operation is selected from the group consisting of producing a warning dialog, authorizing the task instance request, obtaining the current task instance count, terminating a task instance request, registering the unique task identifier, incrementing a task instance count, and activating a read-only mode.

8. A system for managing task instances, the system comprising:
a programmable device configured to receive a task instance request, the task instance request comprising a unique task identifier;
the programmable device further configured to authorize the task instance request and register the unique task identifier if the unique task identifier is not currently registered; and
the programmable device further configured to perform a task-specific operation if the unique task identifier is currently registered.

9. The system of claim 8, wherein the server is further configured to unregister a unique task identifier by invoking a task termination function in response to a task termination request.

10. The system of claim 8, wherein the server is further configured to conduct an atomic operation when comparing registered unique task identifiers with the unique task identifier associated with the task instance request.

11. The system of claim 8, wherein a registered unique task identifier comprises a unique task identifier stored in a task repository.

12. The system of claim 11, wherein the task repository is selected from the group consisting of an array, a vector, or a hashmap.

13. A signal bearing medium tangibly embodying a program of machine-readable instructions executable by a digital processing apparatus to perform an operation to manage task instances, the operation comprising:
receiving a task instance request, the task instance request comprising a unique task identifier;
invoking an authorization function corresponding to the unique task identifier;
the authorization function configured to authorize the task instance request and register the unique task identifier if the unique task identifier is not currently registered; and
the authorization function further configured to perform a task-specific operation if the unique task identifier is currently registered.

14. The signal bearing medium of claim 13, further comprising unregistering a unique task identifier by invoking a task termination function in response to a task termination request.

15. The signal bearing medium of claim 13, wherein the authorization function is further configured to conduct an atomic operation when comparing registered unique task identifiers with the unique task identifier associated with the task instance request.

16. The signal bearing medium of claim 13, wherein a registered unique task identifier comprises a unique task identifier stored in a task repository.

17. The signal bearing medium of claim 16, where in the task repository is selected from the group consisting of an array, a vector, or a hashmap.

18. The signal bearing medium of claim 13, wherein the authorization function is further configured to increment a task instance count with each newly registered unique task identifier.

19. The signal bearing medium of claim 13, wherein the task-specific operation is selected from the group consisting of producing a warning dialog, authorizing the task instance request, obtaining the current task instance count, terminating a task instance request, registering the unique task identifier, incrementing a task instance count, and activating a read-only mode.

20. A method for managing task instances, the method comprising, the method comprising:
receiving a task instance request, the task instance request comprising a unique task identifier;
invoking an authorization function corresponding to the unique task identifier;
the authorization function is configured to authorize the task instance request and register the unique task identifier if the unique task identifier is not currently registered; and
the authorization function further configured to perform a task-specific operation if the unique task identifier is currently registered.
